(19) United States
(12) Patent Application Publication
(10) Pub. No.: US 2005/0133728 A1
(43) Pub. Date: Jun. 23, 2005

(54) Method and system for in-situ calibration of a dose controller for ion implantation

(75) Inventors: Tamer B. Onat, Winchester, MA (US); Rajen Sud, Burlington, MA (US); Gregory R. Gibilaro, Topsfield, MA (US); Joseph P. Dzengeleski, Newton, NH (US)

Correspondence Address: Mark Superko;Varian Semiconductor Equipment Associates, Inc., 35 Dory Lane, Gloucester, MA, 01930-2297, US

(73) Assignee: Varian Semiconductor Equipment Associates, Inc., Gloucester, MA (US)

(21) Appl. No.: 10/744,250

(22) Filed: Dec. 22, 2003

(51) Int. Cl. H01J 3/14

(52) U.S. Cl. 250/397

(57) ABSTRACT

A systematic in-situ analysis is provided for ensuring that a uniform and accurate ion implantation dose for workpieces is being realized. Prior to implantation the system determines whether the calibration of a dose controller is within predetermined tolerance values. If the dose controller is outside of these values, the implantation process is halted so that the calibration can be remedied without further damaging any workpieces by mis-dosing.

### BACKGROUND

(1) Field

The disclosed methods and systems relate generally to semiconductor processing, and more particularly to performing an in-situ calibration test of a dose controller in an ion implantation process.

(2) Description of Relevant Art

Some challenges of semiconductor manufacturing include providing a manufacturing process that produces uniform and controlled doses of materials into semiconductor wafers. When implanting ions to the wafers, it is important to implant a uniform and accurate dose to produce devices having proper operating characteristics.

In conventional ion implanters, a dose controller measures the current of the ion beam. Typically, a Faraday cup is used to measure the dose by converting the detected beam current into an electrical current. A dose controller receives and monitors the electrical current signal and monitors and controls the implant dose so that the wafer is implanted with the proper dose. If the dose controller does not receive an accurate measurement, the wafer will be implanted with an improper dose and thereby create an undesirable under-dose or over-dose implantation into the wafer. Such under- and over-dose conditions cause wafers to be scrapped which increases the manufacturing cost. Semiconductor manufacturers require that the ion implantation system delivers a known and accurate implantation.

The calibration of the dose controller is important for achieving a proper dose level. The amount of calibration offset is directly proportional to amount of dose shift. For instance, if the calibration is off by a known percentage variation, then the expected dose will shift by the same percentage variation. Similarly, for sheet rho measurements, a miscalibration of a known percentage variation will cause a dose shift of the same percentage. The dose controller is calibrated before initial installation, typically by a NIST traceable current source. Thereafter, the dose controller is only re-calibrated when the accuracy of the dose is suspect or at set time intervals. However, components of the dose controller may subtly drift over time without detection such that the dose controller falls outside of the desired tolerance values.

Presently, to determine whether the dose controller is within tolerance, a DC current source test is typically performed. In this DC current source test, the accuracy of the dose controller is only checked whenever a system operator determines that a dosing variation outside of the desired tolerances may be occurring. Oftentimes, when a dosing variation concern is raised, the dose controller will be replaced without making a full analysis of whether the dose controller is within tolerance. Therfore, a systematic in-situ analysis is desired for ensuring that a uniform and accurate implantation dose is being realized.

Other objects and advantages will become apparent hereinafter in view of the specification and drawings.

### BRIEF DESCRIPTION OF THE DRAWINGS

FIG. 1 illustrates a block diagram for a dose control system according to an embodiment of the present invention;

FIG. 2 illustrates a flow chart for a method utilizing a dose control system according to an embodiment of the present invention;

FIG. 3(a), 3(b), and 3(c) illustrate timing diagrams for the system according to an embodiment of the present invention;

FIG. 4 illustrates a flow chart for a method utilizing a dose control system according to another embodiment of the present invention; and

FIG. 5(a), 5(b), 5(c), and 5(d) illustrate graphs of integration signal outputs vs. time for various offset conditions of the dose controller.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the disclosed systems or methods.

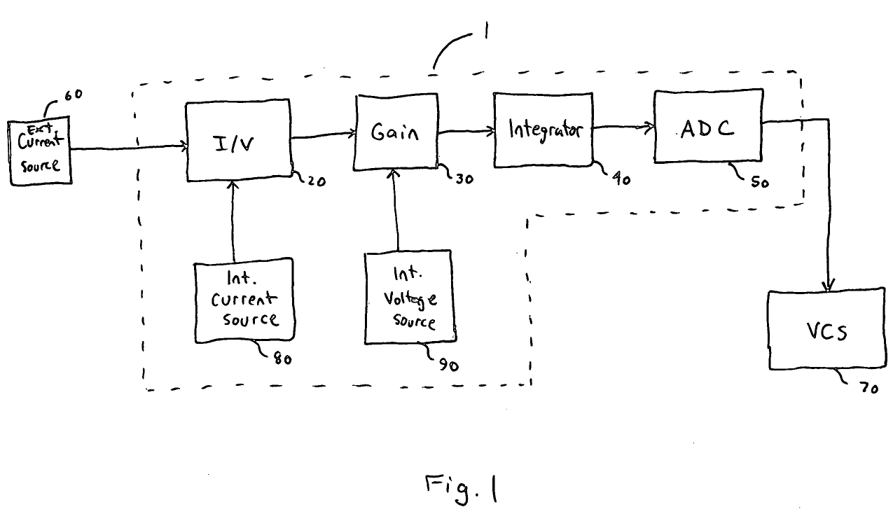

A block diagram for a dose controller 1 according to an embodiment of the present invention is illustrated in FIG. 1. The dose controller 1 is connected to an external current source 60 and a processor 70. The dose controller 1 receives a current from the current source 60 which is converted to a voltage by an I/V converter 20. An internal current source 80 also applies a current to the I/V converter 20 for outputting the voltage therefrom. A gain stage 30 receives the voltage from the I/V converter 20 (or a voltage directly if a reference voltage is used) and a voltage from an internal voltage source 90. Thereafter, the signal passes to an integrator 40 and an analog to digital converter 50. The output of the analog to digital converter 50 is input to a controller system (VCS) 70 so that calibration of the dose controller 1 is performed automatically in real time prior to implantation of a batch of workpieces or wafers. For example, the calibration may be performed during the set up of the implanting tool before every batch of a predetermined number of wafers, such as 100 wafers. If the VCS 70 determines that the calibration has drifted out of the desired tolerances, the VCS 70 generates a signal for stopping the implantation process and generates an error message indicating that a current source test should be completed to verify this condition. As a result, this real time test limits wafers or workpieces from being overdosed and thereby reduces the amount of wafers that are scrapped.

In another embodiment of the present invention, a procedure for checking the calibration can also be done using the internal voltage and/or current source. The internal and external sources can be combined and utilized in many ways. In FIG. 1, the internal current source 80 may be connected with the I/V converter 20 whereas the internal voltage source 90 may be applied after the I/V converter 20. The hardware topology of FIG. 1 may be changed in many ways to obtain the same result. The dose controller 1 can also be auto-calibrated to null out its error. This can be done using the internal current source 80 or the external current source 60. A self test can also be used with a pulsed signal. The present embodiment may use a square waveform as well as sine, sawtooth, triangular and other waveforms as required for the particular application.

The real time test is also applicable to other devices and systems in further embodiments of the present invention. For instance, current sources, voltage sources and other tools that perform current and/or voltage measurements may incorporate this test. In one embodiment, this real time test may check the cabling and Faraday detectors or cups of the implant system. This checking method can be done by sending a signal from the dose controller 1 or from the Faraday cup. The command signal can be generated manually from the dose controller 1 or the Faraday cup or automatically from the VCS 70. This check can be performed during routine maintenance or before every setup. The dose controller 1 also creates a scan or Trek amp signal. The dose controller 1 can create this waveform and check its shape for comparison with a commanded waveform in real time. This can be done inside the dose controller 1. Also, the feedback signal (the signal that originates from the dose controller 1 going to the Trek amps and the voltage applied to scan plates of the implanter which returns to the Trek amps and then to the dose controller 1, for example) from the scan plates can be checked by the dose controller 1 (or the VCS 70) check by sending the signal to the Trek amps. This test can be done during setup or during maintenance and the check interval can be adjusted. Reference checks may be added as archivable variable that are added to implant logs so that a quick and easy determination may flag a possible error condition.

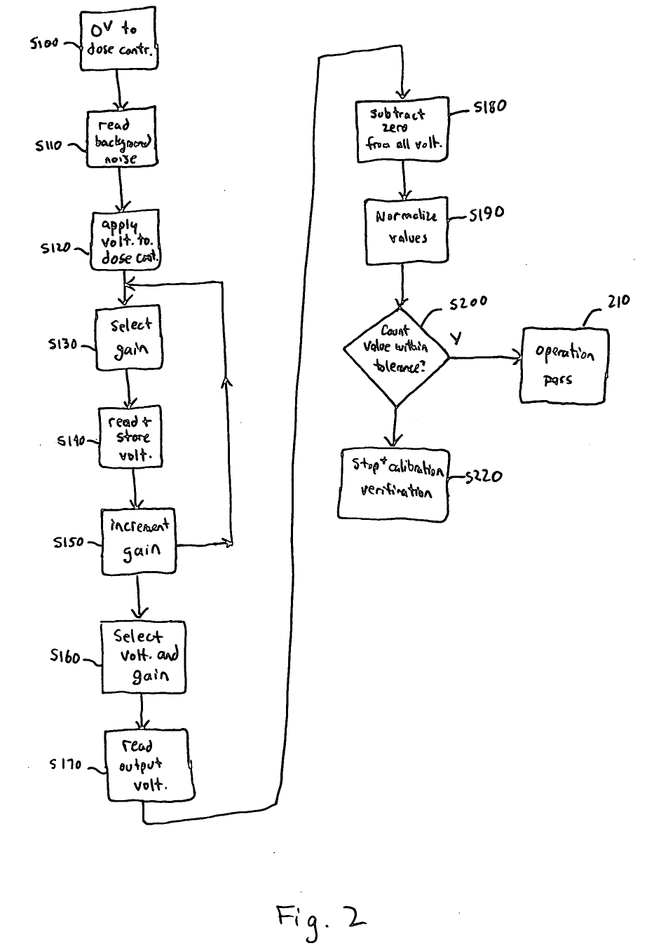

FIG. 2 illustrates a flow chart for steps in determining the implantation accuracy of a dose controller with reference to the block diagram of FIG. 1 according to an embodiment of the present invention. At step S100, the internal voltage of the dose controller is set to 0V. A value for any background noise is read and stored at step S110. This background noise or offset voltage is important to determine because the dose controller 1 is designed to be always positive. If the offset is negative, the integrator 40 is required to overcome that voltage before the actual dose registers. The ADC 50 that samples the output of the integrator 40 uses a 0V to 10V topology instead of a −5V to 5V topology so that all negative voltages are reported as zero. Not detecting or purposely designing for this offset would result in an overdose proportional to the offset voltage. In the present embodiment, the dose controller 1 may check for the background noise level just before integration is started and also for any offset voltage. If the offset voltage is negative or even less than a predetermined threshold of a slightly positive value, the dose controller 1 detects a possible fails condition and therefore prevents an overdose condition and scrapping of wafers. This logic of course can be expanded to digital integrators. For −5V and +5V ADC topologies, the negative offset may not be an issue. In this case, one could design a system where the offset is not controlled. Prior to integration, the offset would need to be measured and subtracted from the final outcome. Though this topology solves the problem of offset, it comes at the cost of not using 50% of the lower scale at all.

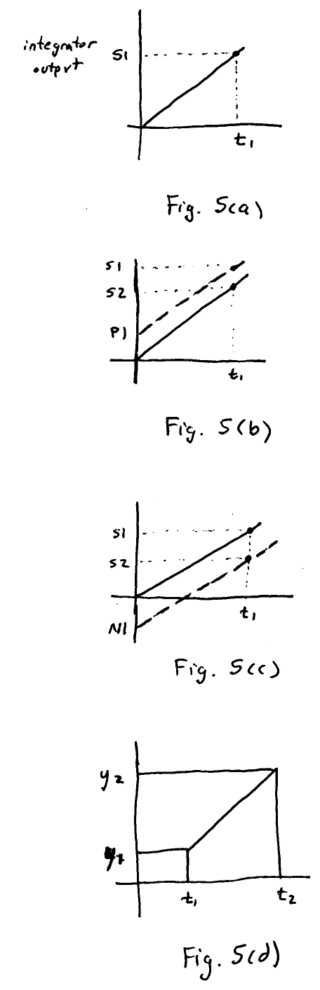

FIG. 5(a) illustrates an ideal integrator which has no offset so that the integration may be performed in a straight forward manner by measuring S1. If a positive offset value of the integrator (P1 in this example) occurs as shown in FIG. 5(b), the target dose S2 can be found from the calculation S2=S1−P1. However, in the case of a negative offset as shown in FIG. 5(c), an additional check may be performed to ensure that the integration is performed on a positive integrator output signal. As shown in FIG. 5(d), current measurements y1 and y2 are performed. If y2−y1 is within a ±1% value of the target, a possible fail condition is detected and the implant is stopped.

Next, one voltage is applied to the dose controller 1 at step S120 during the set up and a gain is selected at step S130. At step S140, the voltage output is read and stored, then the gain is incremented at step S150. Steps S130, S140 and S150 are repeated until all of the gain values are incremented and selected. For instance, x1, x2, x4 and x8 gain values may be incremented for the test in the present embodiment.

After the gain values are incremented and stored, a predetermined voltage and gain are selected at step S160, 5V at x1 gain for example, and an output voltage is read at step S170. At steps S180 and S190, zero is subtracted from all of the voltages and the values are normalized to a 1V reference, respectively. The normalized value is then compared to a predetermined count value at step S200. For instance, when 1V at x1 is selected, the count value is 6400, for 1V at x2, the count value is 12,800, for 1V at x4, the count value is 25,600 and for 1V at x8, the count value is 51,200. If this count value is within a predetermined tolerance, 0.5% for example, the operation passes and implantation may proceed from step S210. However, if the count value is not within the tolerance, the implantation operation is stopped and the calibration verification of the dose controller is performed at step S220.

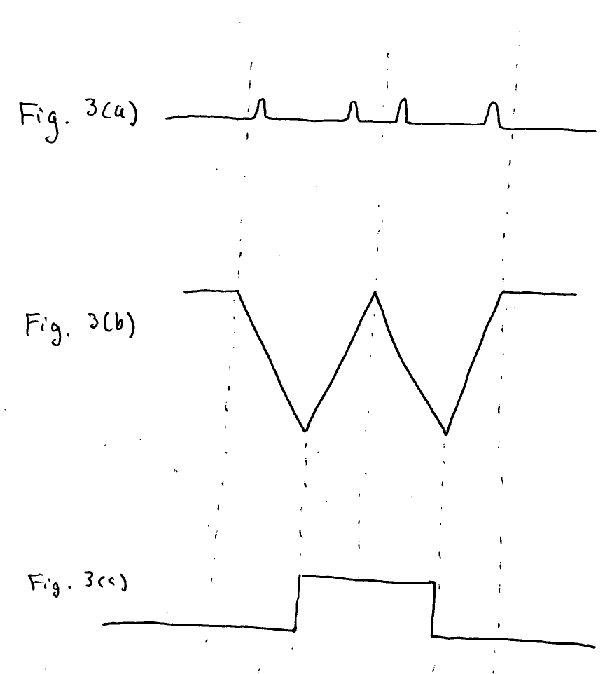

FIGS. 3(a), 3(b), and 3(c) illustrate a timing diagram for an embodiment of the present invention. FIG. 3(a) illustrates a beam signal pulse from the ion implanter corresponding to closed loop Faraday signals. A waveform of the scan beam is shown in FIG. 3(b) which represents four scanning sweeps of a wafer by applying the potential to scan plates of the integrator. The integration window in this embodiment is shown in FIG. 3(c).

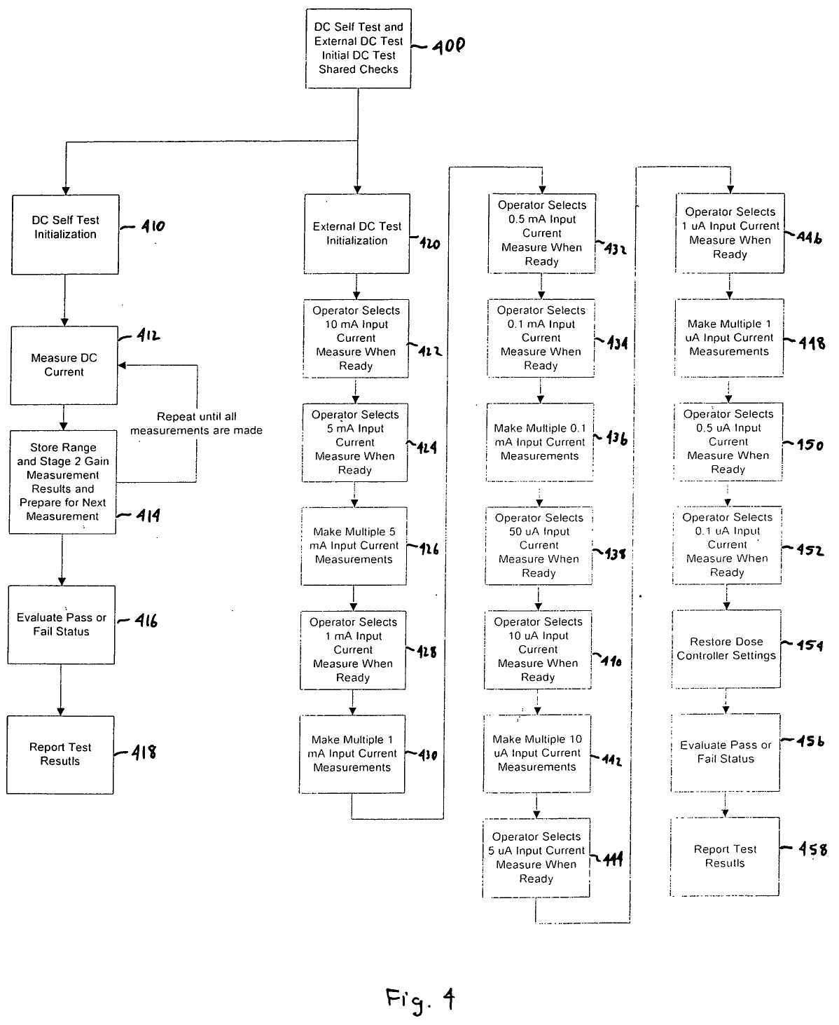

A DC test flow chart 400 is shown in FIG. 4 for performing a DC self test during beam set up or beam tuning in a fully automated manner to prevent auto wafer implantation upon test failure according to an embodiment of the present invention. Also, an external DC test is shown for measuring current from an external DC current source, such as an NIST reference DC current source, in a semi-automatic sequence initiated by a user with interactive instructions to be performed by the user. The DC self test utilizes an internal DC reference current source of the dose controller. The internal current source reference may generate DC currents in a range of 1 mA to 20 uA in one application of the present embodiment. The DC self test initialization is performed at step 410 for the measurement and reference values. The DC current is measured at step 412 and the range and gain measurement results are stored at step 414. The test prepares for the nest measurement and repeats steps 412 and 414 until all of the predefined measurements are made. The pass/fail status of these measurements is evaluated at step 416 and the test results for the DC self test are reported at step 418.

The external DC test is a semi-automatic test where a user is guided through measurements by the controller. Generally, the user is prompted to a request for a particular range and gain to be set on the external current source and the controller sets up the range and gain settings required and makes an integrated beam current measurement. The user may be prompted to connect cables and adjust external current source settings. The data is recorded and an error percentage is computed from the requested input current for indicating pass/fail status. More particularly, an external DC test initialization is performed at step 420. A first input current of 10 mA is selected and measured when the user has completed the request prompts at step 422. Next, a second input current of 5 mA is selected and measured at step 424 and multiple 5 mA measurements (for example, two measurements are different gains) are performed at step 426. A third input current of 1 mA is selected and measured at step 428 and multiple 1 mA measurements are performed for a plurality of range and gain combinations at step 430.

A fourth input current of 0.5 mA is selected and a single measurement is made at step 432. Next, a fifth input current 0.1 mA is selected and measured at step 434 and then multiple 0.1 mA measurements may be performed at step 436. 50 uA and 10 uA input currents are respectively selected and measured at steps 438 and 440. Multiple 10 uA measurements may be performed at step 442. Next, 5 uA and 1 uA input currents are respectively selected and measured at steps 444 and 446 with multiple 1 uA measurements being performed at step 448. The last input currents of 0.5 uA and 0.1 uA are respectively selected and measured at steps 450 and 452. Thereafter, the dose controller settings are restored at step 454 and the pass/fail status is evaluated at step 456. Finally, the test results are reported at step 458 for the external DC test.

What has thus been described are systems and methods for preventing overdosing of workpieces and wafers during an implantation process. The methods and systems described herein are not limited to a particular hardware or software configuration, and may find applicability in many computing or processing environments. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) is preferably implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor” or “the processor” can be understood to include one or more processors that can communicate in a stand-alone and/or a distributed environment(s), and can thus can be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

1. A system for in-situ dose monitoring during ion implantation of workpieces, comprising:
a detector for measuring a beam current during ion implantation of the workpieces;
a dose controller for controlling the beam current in response to the beam current measured by the detector; and
a processor for comparing predetermined calibration values of the system to a tolerance range, said processor stopping the ion implantation process when the calibration values are determined to be outside of said tolerance range.

2. A system according to claim 1, wherein said processor compares an offset or background noise level prior to implanting and stops the implanting when the offset or background noise level is negative or below a predetermined threshold.

3. A system according to claim 1, wherein said processor communicates and compares external peripheral sources connected thereto.

4. A method for in-situ dose monitoring during ion implantation of workpieces, comprising the steps of:
(a) measuring a beam current during ion implantation of the workpieces;
(b) controlling the beam current in response to the beam current measured at said step (a);
(c) comparing predetermined calibration values a tolerance range; and
(d) stopping the ion implantation process when the calibration values compared at said step (c) are outside of said tolerance range.
